(19) United States
(12) Patent Application Publication
(10) Pub. No.: US 2005/0254701 A1
(43) Pub. Date: Nov. 17, 2005

(54) Method for time synchronization of information measured by means of imaging

(75) Inventors: Pertti Aimonen, Pirkkala (FI); Hannes Kalaniemi, Jyvaskyla (FI); Harri Mustonen, Jyvaskyla (FI)

Correspondence Address: OLIFF & BERRIDGE, PLC, P.O. BOX 19928, ALEXANDRIA, VA, 22320, US

(73) Assignee: Metso automation Oy, Helsninki (FI)

(21) Appl. No.: 10/509,187

(22) PCT Filed: Mar. 26, 2003
(86) PCT No.: PCT/FI03/00231

§ 371 Date: May 24, 2005

(30) Foreign Application Priority Data
Mar. 27, 2002 (FI) 20020585

(51) Int. Cl. G06K 9/00

(52) U.S. Cl. 382/151

(57) ABSTRACT

The invention relates to a method for synchronizing information produced by imaging optical measuring devices (1-N) which monitor the manufacturing and/or finishing process of a fibre web, in relation to the movement of the fibre web in the machine direction, which method comprises the steps of monitoring the moving fibre web and/or a moving means involved in its processing in the machine direction by means of imaging measuring devices (1-N) placed in successive measuring positions in the machine direction, and searching the information recorded by imaging at different measuring positions, for images, or the like, relating to the same local area of the fibre web, for their analysis and/or storage. In the method according to the invention, the images, or the like, recorded in the different measuring positions, are searched, by digital pattern recognition, for a feature/features (30) relating to the same local area of the fibre web, and the travel time delays of the fibre web between the different measuring positions are determined on the basis of time data included in said feature/features (30) upon the recording of images, or the like, in the different measuring positions. The invention makes it possible to automatically synchronize information measured by imaging in a significantly more accurate and adaptive way than in prior art.

### FIELD OF THE INVENTION

The invention relates to a method according to the preamble of the appended claim 1 in the control of the quality or the condition of a fibre web on the basis of optical diagnostics by imaging, the control being applied in connection with the manufacturing or finishing process of a paper web.

### BACKGROUND OF THE INVENTION AND PRIOR ART

There is a constant aim to increase the web speeds utilized in the manufacturing and finishing processes of paper, paperboard and other corresponding web-like materials in order to improve the production rate. When the web speeds are increased, it is, however, necessary to monitor the function and state of the process in a more detailed manner than before in order to avoid an increase in web breaks that impair the production rate and in various defects in the quality of the fibre web. One method, which has been found to be very efficient in the real-time monitoring of a rapidly moving fibre web and its path, is to use optical diagnostic methods. Advantages of the optical methods include, for example, the possibility to take measurements of an object in a contactless manner and to take the measurements with a rapid time response. Several examples of applying optical methods in the manufacturing and finishing processes of web-like materials are known from prior art. The present invention relates to optical imaging diagnostics for storing a spatially resolved visual image or other spatially resolved, optically measurable data about an object to be examined. In optical imaging systems, the detectors that are currently used are typically electrical matrix or line scan cameras, such as CCD cameras (charged coupled devices).

U.S. Pat. No. 5,821,990 discloses, on the principle level, a monitoring system in which measuring positions are arranged at different locations along the process to be monitored. In these measuring positions, the measuring devices used can be, for example, video cameras, and said monitoring system is suitable for use also in connection with the paper manufacturing process.

One example of commercially available optical systems, which are particularly suitable for the real-time monitoring of a fibre web and its path, are so-called web runnabiliby monitoring (WRM) systems. These systems may comprise even several tens of camera units arranged to record an image of the fibre web and the machine means related to its processing at different points in the process. The primary function of WRM systems is to visually observe and analyze web breaks and the web runnability phenomena of the fibre web related therewith. The analysis is made by monitoring video sequences recorded in connection with said events in different camera positions along the path.

The basic principle of the WRM system is shown in FIG. 1. The camera units 1 to N may be placed, according to the need, at different points of the path of the fibre web, from the wet end of the paper machine all the way to the reeling up of the paper web. At present, single camera units used in the system are typically CCD cameras which operate on the visible wavelength range and which produce an analog video signal 10 to be transmitted to computers used as image processing units 11, 12 for image capturing, storage, digital image processing, and analysis. The results of the image analysis can be viewed via a user interface 13 placed in a control room, and the visual image produced by the camera units 1 to N can also be viewed in its unprocessed form in real time, if necessary, via video monitors placed in the control room.

Troubleshooting typically requires the examination of video samples recorded from different steps of the manufacturing process, i.e. recorded with the different camera units 1 to N. Video sequences corresponding to the same point of the moving fibre web but recorded in different camera positions 1 to N at different times can be used to find out which step in the process is the origin of the cause for a defect. For example, if a break caused by an edge defect or a hole in the web is detected in the reel-up of the paper machine (camera unit N in FIG. 1), one must first determine if a web defect causing the break is already visible in an earlier step in the manufacturing process, that is, for example in images stored by camera units N-1, N-2. To determine this, the user of the monitoring system must find, from the video recordings of the camera units preceding the reel-up, the corresponding web section where the web defect that caused the break can be observed for the first time.

Naturally, it will be obvious that in practice, problems in the runnability of the paper web must be solved as soon as possible to eliminate the cause of the disturbance as soon as possible and thereby to prevent a decrease in the production or an impairment of the quality of the product.

In most modern WRM monitoring systems, the recordal and processing of video signals are performed in digital format. This makes it possible to synchronize image material recorded with different camera units in such a way that the system takes into account the delay in the time of travel of the web between the different camera positions. Because of a movement in the longitudinal direction, i.e. machine direction of the web, the same point of the web is recorded at different times by camera units placed, for example, in the wire section, in the press section, in the drying section, and in the reel-up. The synchronization of image material taking into account the delay in the travel time makes it possible to present image material corresponding to the same point simultaneously in displays corresponding to different camera positions. This synchronization of images to be recorded in different camera positions is one of the most important features of the monitoring system, because it substantially facilitates the user's work and thereby accelerates the troubleshooting of runnability disorders in practice.

Finnish public patent application 990428 discusses the problems relating to said synchronization and presents a solution to improve the synchronization. In the method presented in the application, an area of successive images at each camera position, limited in the longitudinal direction of the web, in which area the synchronization point is placed according to an approximate computation, is displayed to the user. In this way, the user's work is facilitated by limiting the number of images to be examined, which the user must go through to find, for example, images representing a given edge defect in the web in the image material recorded in different camera positions. However, the method according to the patent application 990428 only makes an approximate synchronization of the image material possible, wherein the user must improve the synchronization manually by examining and comparing single images.

In principle, the synchronization between different camera positions is simple, if the accurate speed of propagation of the web as well as the distance travelled by the web between the different camera positions are precisely known. Typically, in present systems, the displaying of exactly the same web point from different camera positions in a synchronized manner would require that the delay in the travel time between two camera positions is known at an accuracy of at least 20 ms. When the imaging frequency is 50 or 60 images per second, said time corresponds substantially to the time difference between two successive images. In the future, imaging frequencies are expected to increase (to 100/120 images per second), which will further tighten said accuracy requirement.

At present, the synchronization is based on inputting the distances between the camera positions (the distance travelled by the web between the different camera positions) to the camera monitoring system at the stage of introduction or configuration, and inputting the web speed as measurement data from the automation system controlling the paper machine. To improve the synchronization, the web speed is input separately from each operating group of the paper machine to the monitoring system, wherein also the differences in the operation between the different operating groups are taken into account. However, even this procedure does not provide a sufficiently precise synchronization, because the web speed can normally not be measured at a sufficient precision and/or the exact length of the web between the different camera positions is not accurately known.

The measurement of the web speed according to prior art is based on measuring the rotation speed of rolls interacting with the web at the centres of the rolls. Further, the peripheral speed of the rolls, corresponding to the web speed, is computed on the basis of information on the diameter of the rolls. However, the roll diameters are changed, for example, as a result of thermal expansion and pulping of the rolls, wherein the speed data determined by using the roll diameter is also changed accordingly.

In practice, the synchronization between the camera units must be tuned to be more accurate in connection with the configuration and introduction of the camera system, by correction factors suitable for the result of computation based on the information on the distance and the web speed. The synchronization can be tuned, for example, by marking the fibre web on the wire section of the paper machine with a spot of a colouring agent which can be detected in the image material to be recorded in the different camera positions. The tuning is now performed by the user who corrects the distance data between the different camera positions with suitable correction factors until the images are accurately synchronized with each other. However, this procedure will not lead permanently to a satisfactory final result, because it is only used to correct inaccuracies in the distance between the camera units (the distance travelled by the web). Thus, the tuned synchronization will only function correctly in use situations corresponding precisely to the tuning conditions. However, if changes take place in, for example, the roll diameters, the operating differences between the operating groups, the speed of the paper machine, or other corresponding factors effective on the travel time delay, the accuracy of the synchronization is decreased.

Basic Principle and Most Important Advantages of the Invention

It is a primary aim of the present invention to synchronize information, measured by means of imaging in different measuring positions at different steps of a process, with each other in time, in the control of the quality or the condition of a fibre web and/or movable means relating to its processing, on the basis of optical imaging diagnostics.

To attain this purpose, the method according to the invention is primarily characterized in what will be presented in the characterizing part of the independent claim 1.

The other, dependent claims will present some preferred embodiments of the invention.

The essential basic idea of the invention is that information on the fibre web and/or a moving means relating to its processing (for example, wires, felts, rolls, reels, or the like), measured by means of imaging at different measuring positions, is scanned to find out single recognizable features relating to specific local areas of the fibre web by means of digital pattern recognition. Such a recognizable local feature may be, for example, an edge defect or a hole occurring in the fibre web, or a “tail” of the fibre web running through the paper machine in connection with a break of the fibre web. According to the invention, the same single feature of the fibre web is detected from information recorded at different measuring positions, to find out the exact travel time delay between the different measuring positions, on the basis of which the synchronization of the measuring positions can now be performed accurately.

Consequently, the method of the invention makes it possible to tune the automatic synchronization during the use of the monitoring system to correspond to varying process conditions, such as changes in the speed of the fibre web between different parts of the paper machine.

The invention is particularly suitable for use in monitoring systems recording visual image material, such as the WRM system, but the invention is also suitable for use in connection with other imaging measuring systems, in which information on a fibre web and/or a moving means relating to its processing is stored in an optical and location-resolved manner by imaging measuring devices placed at different locations in the process.

The invention makes it considerably faster and easier to recognize the cause of disturbances in the process, because the monitoring system can now automatically synchronize the information measured at different measuring positions. Thus, the user does not need to go through the measured information manually when looking, for example, for images representing a given edge defect in the web from the image material recorded at different camera positions. Furthermore, the invention makes it possible to automatically analyze the measuring results by computer significantly more efficiently than before, as well as to compile statistical material relating to disturbance situations in a more reliable manner than before. By means of the invention, use can be made of all the benefits of the higher imaging frequencies available in the future, avoiding, for example, the unnecessary storing of image material in the memory of the system, because the storing can be limited to areas defined in more detail by means of the invention.

The following, more detailed description of the invention with examples will more clearly illustrate, for anyone skilled in the art, preferred embodiments of the invention as well as advantages to be achieved with the invention in relation to background art.

### BRIEF DESCRIPTION OF THE DRAWINGS

In the following, the invention will be described in more detail with reference to the appended drawings, in which

FIG. 1 shows the basic principle of the WRM system according to prior art,

FIG. 2 shows, in a principle view, the synchronization between different camera units according to prior art, and

FIG. 3 illustrates, in a principle view, an automatic synchronization method based on pattern recognition according to the invention.

### DETAILED DESCRIPTION OF THE INVENTION

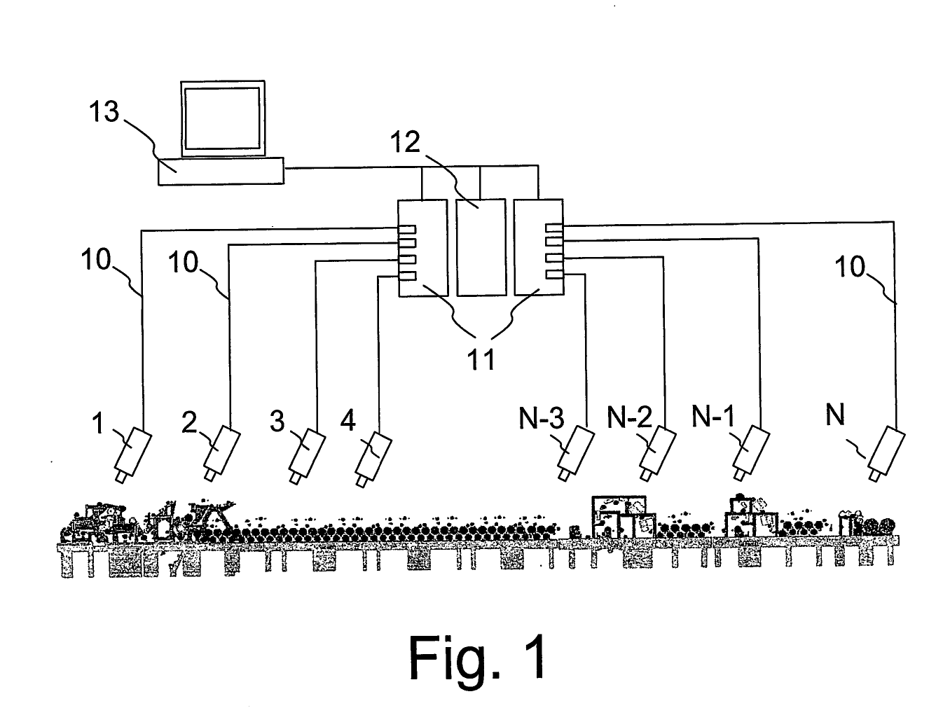

FIG. 1 has already been discussed in connection with the description of prior art.

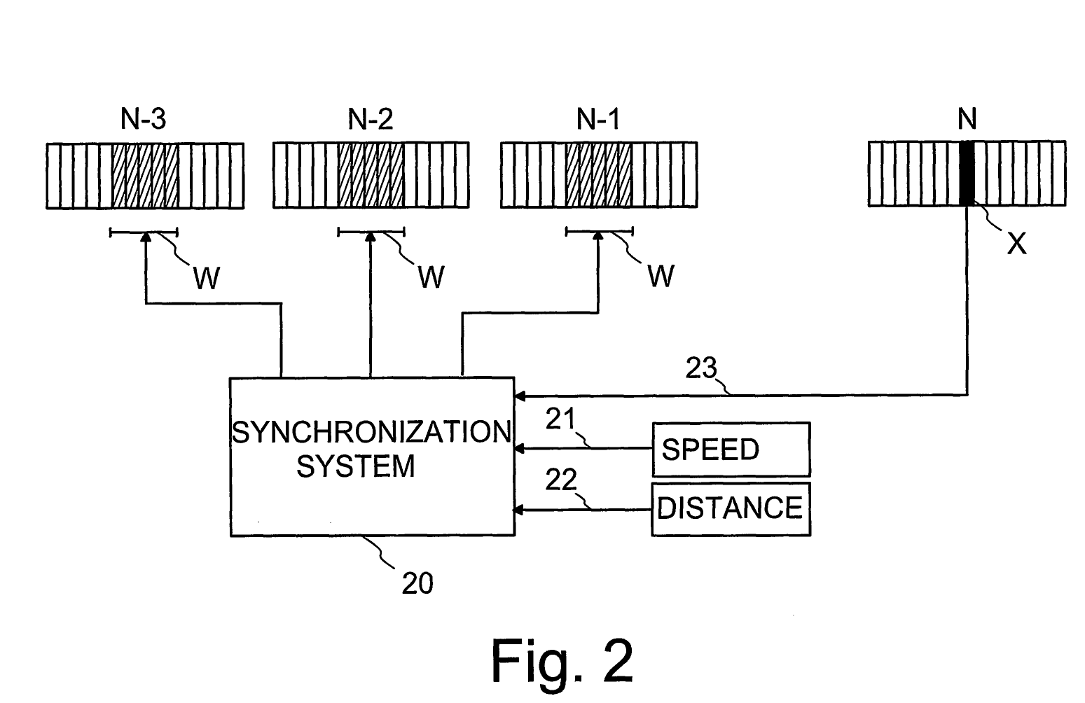

FIG. 2 further shows, in a principle view, the approximate synchronization method of image material according to prior art, as described, for example, in Finnish patent application 990428.

The functions shown in FIG. 2 are typically performed in computers or corresponding devices used as image processing units 11, 12 in FIG. 1. For the synchronization, information about the speed 21 of the fibre web as well as information about the distances 22 between the camera units used in the monitoring system is input in the synchronization system 20.

When the user or the monitoring systems selects, from the image material of a camera N, an interesting image X, which image X shows, for example, a tear in the fibre web, the synchronization system 20 can use the event time data 23 relating to the image X to determine, by simple calculations and by using the speed and distance data 21, 22, the image sequences W corresponding to the same point of the web in the image information recorded by other, preceding cameras N-1, N-2, N-3 in the travel direction of the web. According to prior art, by selecting the temporal length of the image sequence W to be sufficiently long, one can now be sure that the section of the web corresponding to the image X from the camera N can be found in the image material recorded by the different cameras N-1, N-2, N-3 within said image sequence W. Because of the earlier mentioned inaccuracies related to the determination of the travel time delay, however, the accuracy of the above-described approximate synchronization is not sufficient to indicate the single images corresponding to the same point in the web recorded by different cameras, that is, to set the length of the image sequence W to correspond to substantially one image.

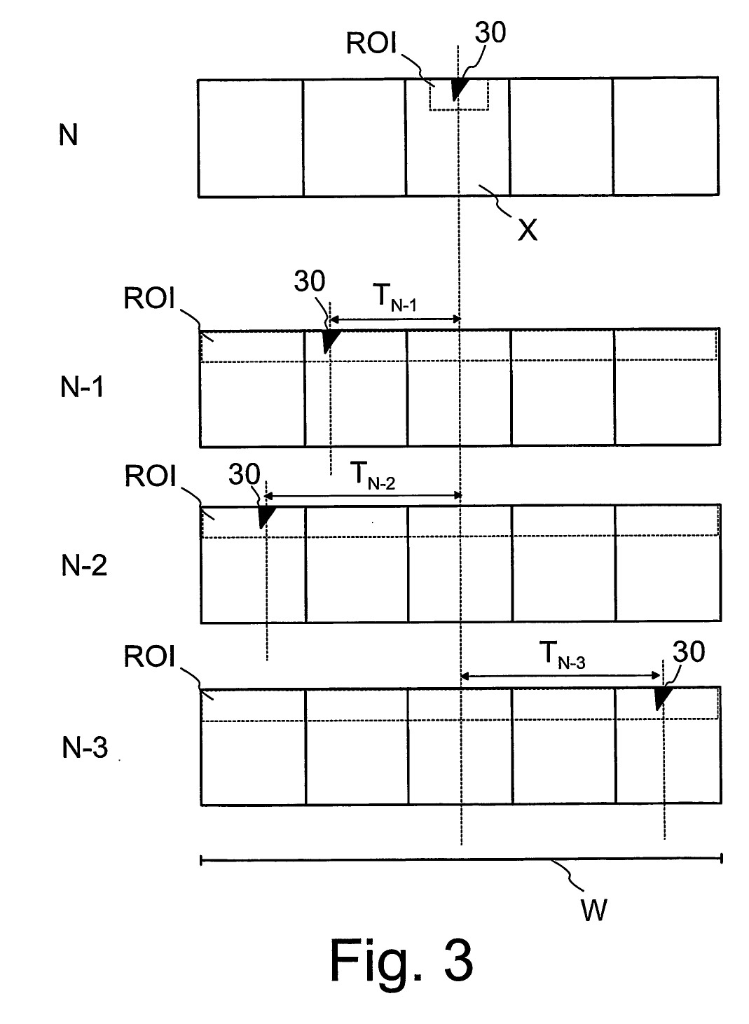

FIG. 3 illustrates, in a principle view, an automatic synchronization method based on pattern recognition according to the invention.

In FIG. 3, image X is shown uppermost among the successive images recorded by a camera N, in which image X a recognizable feature 30 is detected in the fibre web. In this example case, the feature 30 may be, for example, a defect at the edge of the web, such as an incipient tear of the web. According to prior art, from the image material of the cameras N1, N-2, N-3, an image sequence W is determined by means of approximate synchronization, which, in the example case, comprises a sequence of five images for each camera.

According to the present invention, the means of digital image processing and pattern recognition are used to analyze the images of the cameras N, N-2, N-3 in the range of the image sequence W to look for the same feature 30 in the image material from different cameras, wherein it is possible to determine the exact travel time delays between the different measuring positions to improve the synchronization between the different measuring positions. In FIG. 3, the tuning by the approximate synchronization by the method of the invention is illustrated by means of time differences T_{N-1}, T_{N-2} and T_{N-3}. According to the invention, said time differences are thus determined by means of digital image processing and pattern recognition of image material from the different cameras 1 to N without specific measures required of the user.

When said time differences T_{N-1}, T_{N-2} and T_{N-3} are input further in the synchronization system 20, the approximate synchronization based on the speed and distance data 21, 22 can now be made more accurate so that the length W of the image sequence can be set optimally to correspond to one image.

According to the invention, the search for the feature 30 corresponding to the same point in the fibre web in the image material from different camera units is made by using digital image processing and pattern recognition. By using digital image processing methods known as such, an interesting feature 30 of the fibre web can be allocated pattern recognition parameters which represent a feature in the image X, for example the size and shape of the feature. These parameters are utilized to find the feature in the image material produced by the other camera units. The image material from different camera units can also be processed by image processing methods known as such, for example, by removing so-called background which remains substantially unchanged in the images, wherein abnormal features deviating from said background are emphasized. Furthermore, the images can be edited for feature recognition, for example, with respect to the contrast and the scale of grey tones or colours. In the image processing, it is possible to use known filtering, sharpening, size scaling or other corresponding methods of image processing. The invention is in no way restricted with respect to image processing and pattern recognition methods used for recognizing features.

For example, a hole or another defect occurring in the fibre web may change its size and shape when passing through the different sections in the paper machine; therefore, the methods and the parameters used for pattern identification must be selected suitably by not setting too hard criteria for the recognition. To avoid false recognitions, it is possible to use approximate synchronization of prior art to determine the length of the approximate image sequence W in the different imaging positions, in which range the same feature 30 of the fibre web is to be recognized in the image material produced by different camera units. It is obvious that said length of the image sequence W can be selected, depending on the accuracy of the approximate synchronization, to be suitable in each case, and further, to be of different size at different camera units, if necessary.

The method according to the invention is adaptive in its nature; that is, the synchronization will automatically adapt to changes in the process, which change the travel time delay between the different camera units. In a situation in which said travel time delays remain substantially constant for a longer time, the method of the invention can be used continuously to improve the absolute precision of the synchronization more and more.

The tuning of the synchronization according to the invention can be performed either for all or for some of the camera units or measuring units used in the measuring system. The method can be applied automatically and substantially continuously without measures required of the user. It is also possible that the tuning of the synchronization according to the invention is only performed upon request of the user, on the basis of image information recorded in connection with a web break or another corresponding phenomenon. Furthermore, automatic synchronization can also be supported by intentionally causing a clearly distinguishable local feature in the fibre web. At the initial end of the paper machine, the fibre web can be marked, for example, with a spot of a colouring agent. The image material relating to this is recorded, and the automatic recognition of said stored image material and tuning of the synchronization based on it is started according to the invention.

The single features to be found in the image material and relating to specific locations in the fibre web may be, for example, local defects, such as edge defects or holes, occurring in the fibre web. For example, local defects of a coating, which can be detected optically by means of imaging measurements, are also suitable for the purpose. In connection with a break of the fibre web, the “tail” of the fibre web travelling through the paper machine can also be used to improve the synchronization. Particularly in situations, in which the defect to be searched in the images is small in relation to the whole observation area of the image, it is possible to use, if necessary, the so-called ROI principle (ROI=Region of Interest) in the analyses. Thus, instead of examining the whole image area of the camera units, the examination is only focused on a part of the image or observation area, for example on a given width of the web in the transverse direction. This is illustrated with observation areas ROI limited in the transverse direction of the web, marked in FIG. 3. When applying the ROI principle, the analyzing of the images becomes faster and also more reliable. In digital image processing, the speed of the image processing is significantly affected by the size of the images to be processed. When utilizing the ROI principle, the image sizes to be analyzed become significantly smaller in their number of pixels, wherein it is also possible to use pattern recognition algorithms which are more complex and require more computing.

The invention is not limited solely to the analysis of information on the fibre web itself, recorded by means of imaging, but the method can also be used to look for a feature (for example based on marking) corresponding to a given area of the fibre web in information on, for example in wires, felts, rolls, or reels, recorded by means of imaging. When the peripheral speed of the moving means involved in the processing of said fibre web, in relation to the travel speed of the fibre web, is known, it is also possible to use recorded information on them for determining the travel time delays of the fibre web between different measuring positions.

Thanks to the invention, by means of precise synchronization in the longitudinal direction of the fibre web, it is possible, in practice, to recognize the original cause of a web break or a quality defect of the fibre web at a higher certainty. When the defect is detected, for example, by a given camera unit at the final end of the paper machine, the defect can be followed backwards in the travel direction of the fibre web in the paper machine. Thanks to the invention, the search can be limited to as small a number of single images as possible in the image material recorded by the preceding camera units. This makes it possible to find defects, which are smaller than before and thereby more difficult to detect, even at the initial end of the process where they have not yet developed to be well discernible.

After the cause of a web break or a quality defect in the fibre web has been recognized, the cause of said defect can be compiled in statistics. The statistics can be used for the evaluation of the condition of different machine means of the paper machine, such as, for example, drying felts. If the same machine means turns out to be continually the cause of a defect, it is known that said machine means requires either maintenance or replacement.

Thanks to the improved synchronization by means of the invention, the number of images needed for further examination later can be reduced (the length of the image sequence W can be reduced). Due to the smaller quantity of information to be stored in digital format, the images can be stored either in full, without compression of the images, or by using a lower degree of compression. Thus, the image material to be stored remains of high quality, which makes it possible to use more precise analysis methods.

Using the method of the invention, it is possible to better detect and analyze such quick phenomena which cannot be appropriately detected by subjective analyses of prior art and primarily by the user, of image material or other corresponding location-specific measurement data. Thanks to the invention, the more effective statistical utilization of the measurement results helps to design maintenance and repair measures of production equipment better than before. In this way, unforeseen and extra stoppages are avoided.

By various combinations of the methods and device structures presented in connection with the different embodiments of the invention above, it is possible to provide various embodiments of the invention which comply with the spirit of the invention. Therefore, the above-presented examples must not be interpreted to restrict the invention, but the embodiments of the invention can be freely varied within the scope of the inventive features presented in the claims hereinbelow.

Although the invention has been described above primarily in connection with camera systems recording a visual image in the visible wavelength range, the invention is also suitable for the use of other kinds of optical measuring systems, in which location-specific information is collected of an object by means of imaging in the longitudinal direction of the fibre web. The invention is thus suitable for use, for example, in connection with thermal cameras operating in the infrared range, or also in connection with other camera detectors operating in the nonvisible wavelength ranges. Furthermore, the invention is suitable for use also in connection with other measuring devices based on imaging and, for example, spectral resolution.

The significance of the benefits obtained with the invention will be increased further in the future, when higher and higher imaging and measuring frequencies are taken into use.

1-8. (canceled)

9. A method for synchronizing information of different stages of a process produced by optical imaging measuring devices which monitor the manufacturing and/or finishing process of a fibre web, in relation to the movement of the fibre web in the machine direction for monitoring the quality and/or condition of said process, which method comprises the steps of
monitoring the moving fibre web and/or a moving means involved in the processing of the fibre web by means of imaging measuring devices placed in successive measuring positions in the machine direction,
recording the information acquired from said imaging measuring devices in different measuring positions,
searching the information recorded by imaging in the different measuring positions, for images, or the like, relating to the same local area of the fibre web, and
analyzing said images, or the like, relating to the same local area of the fibre web in different measuring positions, for monitoring the quality and/or condition of said process,
wherein the method also comprises the steps of
searching the images, or the like, recorded in the different measuring positions, by digital pattern recognition, for a feature/features relating to the same local area of the fibre web, and
determining travel time delays of the fibre web between the different measuring positions on the basis of time data included in said feature/features upon the recording of images, or the like, in the different measuring positions for automatically synchronizing, with each other in time, said images or the like, recorded in different measuring positions with the movement of the fibre web in the machine direction.

10. The method according to claim 9, wherein in information recorded by imaging in each measuring position, the search is limited to a given sequence comprising successive images or the like, which sequence is defined by means of approximate synchronization based on the distance between the measuring positions and the speed data of the fibre web.

11. The method according to claim 9, wherein in the information recorded by imaging in each measuring position, the search is limited to a given area narrower than the production width of the fibre web in the transverse direction.

12. The method according to claim 9, wherein the information recorded by imaging is processed by methods of digital image processing to emphasize the feature/features to be searched in the fibre web and/or a moving means involved in the processing of the fibre web, to facilitate pattern recognition.

13. The method according to claim 9, wherein the information recorded by imaging is produced with cameras, preferably cameras of the visible wavelength range or thermal cameras operating in the infrared range.

14. The method according to claim 9, wherein the information recorded by imaging is produced with imaging measuring devices based on spectral resolution, for example imaging spectrometers.

15. The method according to claim 9, wherein the information recorded by imaging is produced substantially over the whole production width of the fibre web or on only a part of the production width of the fibre web.

16. The method according to claim 9, wherein the feature to be found in the information recorded by imaging is a local edge defect, a hole, a tear, a coating defect in the fibre web and/or a moving means involved in the processing of the fibre web, such as a wire, a felt, a roll, a reel, or the like; a tail of the fibre web passing through the manufacturing and/or finishing apparatus in connection with an event of break in the fibre web; or a locally discernible phenomenon caused by the user by marking in the fibre web or in a moving means involved in its processing.
